(19) United States
(12) Patent Application Publication
(10) Pub. No.: US 2023/0035101 A1
(43) Pub. Date: Feb. 2, 2023

(54) WIRELESS COMMUNICATION SYSTEM, MONITORING STATION, DEFECT DETECTION METHOD, AND WIRELESS COMMUNICATION PROGRAM

(71) Applicant: NIPPON TELEGRAPH AND TELEPHONE CORPORATION, Tokyo (JP)

(72) Inventors: Toshiro NAKAHIRA, Musashino-shi, Tokyo (JP); Hirantha ABEYSEKERA, Musashino-shi, Tokyo (JP); Shoko SHINOHARA, Musashino-shi, Tokyo (JP); Koichi ISHIHARA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 17/791,195

(22) PCT Filed: Jan. 28, 2020
(86) PCT No.: PCT/JP2020/002980

§ 371 Date: Jul. 6, 2022

(51) Int. Cl. H04W 24/08

(52) U.S. Cl. CPC H04W 24/08

(57) ABSTRACT

In a wireless communication system including a plurality of base stations to which terminal stations are connectable, and a monitoring station which monitors each of the base stations, the monitoring station includes an information collection unit configured to collect wireless environment information including a plurality of information items indicating wireless environments around the base stations and the terminal stations, from each of the base stations, a point calculation unit configured to calculate a total point of points to be respectively provided to a plurality of defect items determined in advance in a case where a determination condition determined in advance for each of the information items is satisfied, and a defect detection unit configured to detect whether or not a defect listed as one or more of the defect items occurs based on the total point calculated by the point calculation unit.

### TECHNICAL FIELD

The present invention relates to a wireless communication system, a monitoring station, a defect detection method, and a wireless communication program.

### BACKGROUND ART

Wireless communication systems using a radio wave in a 2.4 GHz band or a 5 GHz band include, for example, wireless communication systems based on IEEE802.11a standards, IEEE802.11g standards, or the like. Here, an orthogonal frequency division multiplexing (OFDM) modulation scheme can be used to stabilize characteristics in a multipath fading environment and achieve transmission speed of up to 54 Mbit/s.

Further, in a wireless communication system based on IEEE802.11n standards, transmission speed of up to 600 Mbit/s is achieved by using multiple input multiple output (MIMO) in which space division multiplexing is performed in the same wireless channel using a plurality of antennas or using a channel bonding technique in which a frequency channel of 40 MHz is utilized by utilizing two frequency channels of 20 MHz at the same time, in a 2.4 GHz band or a 5 GHz band.

Further, in a wireless communication system based on IEEE802.11ac standards, wireless communication with higher speed and higher efficiency than wireless communication based on the IEEE802.11n standards is achieved by utilizing a channel bonding technique in which up to eight frequency channels of 20 MHz are utilized at the same time as a frequency channel of up to 160 MHz, a multi user MIMO technique in which different signals are transmitted to a plurality of destinations using the same wireless channel at the same time, or the like, in a 5 GHz band (see, for example, Non-Patent Literature 1).

Further, in the above-described wireless communication system, or the like, there is a case where a monitoring station which monitors a service state is provided, and information is periodically collected from each base station to monitor whether or not a defect occurs in service. For example, there is a case where a support center performs unified management also in a case where there are a plurality of sites (see, for example, Non-Patent Literature 2).

### CITATION LIST

### Non-Patent Literature

Non-Patent Literature 1: IEEE Std 802.11-2016, December 2016.

Non-Patent Literature 2: Supported Easy Office Wi-Fi service GIGA RAKU Wi-Fi, [online], NIPPON TELEGRAPH AND TELEPHONE EAST CORPORATION, Accessed Nov. 7, 2019, Retrieved from: https://business.ntteast.co.jp/service/gigarakuwifi/

### SUMMARY OF THE INVENTION

### Technical Problem

However, there has been a problem in related art that even if information is collected from each base station, whether or not a defect occurs in a wireless communication system cannot be efficiently detected.

An object of the present invention is to provide a wireless communication system, a monitoring station, a defect detection method, and a wireless communication program, with which it is possible to efficiently detect whether or not a defect occurs.

### Means for Solving the Problem

A wireless communication system according to one aspect of the present invention is a wireless communication system including a plurality of base stations to which terminal stations are connectable, and a monitoring station which monitors each of the base stations, the monitoring station including an information collection unit configured to collect wireless environment information including a plurality of information items indicating wireless environments around the base stations and the terminal stations, from each of the base stations, a point calculation unit configured to calculate a total point of points to be respectively provided to a plurality of defect items determined in advance in a case where a determination condition determined in advance for each of the information items is satisfied, and a defect detection unit configured to detect whether or not a defect listed as one or more of the defect items occurs based on the total point calculated by the point calculation unit.

Further, a monitoring station according to one aspect of the present invention is a monitoring station which monitors each of a plurality of base stations to which terminal stations are connectable, the monitoring station including an information collection unit configured to collect wireless environment information including a plurality of information items indicating wireless environments around the base stations and the terminal stations, from each of the base stations, a point calculation unit configured to calculate a total point of points to be respectively provided to a plurality of defect items determined in advance in a case where a determination condition determined in advance for each of the information items is satisfied, and a defect detection unit configured to detect whether or not a defect listed as one or more of the defect items occurs based on the total point calculated by the point calculation unit.

Further, a defect detection method according to one aspect of the present invention for detecting whether or not a defect listed as defect items occurs for a wireless communication system including a plurality of base stations to which terminal stations are connectable, the defect detection method including an information collection step of collecting wireless environment information including a plurality of information items indicating wireless environments around the base stations and the terminal stations, from each of the base stations, a point calculation step of calculating a total point of points to be respectively provided to a plurality of defect items determined in advance in a case where a determination condition determined in advance for each of the information items is satisfied, and a defect detection step of detecting whether or not a defect listed as one or more of the defect items occurs based on the calculated total point.

### Effects of the Invention

According to the present invention, it is possible to efficiently detect whether or not a defect occurs.

### BRIEF DESCRIPTION OF DRAWINGS

FIG. 1 illustrates a configuration example of a wireless communication system according to one embodiment.

FIG. 2 is a functional block diagram illustrating an example of functions of a terminal station.

FIG. 3 is a functional block diagram illustrating an example of functions of a base station.

FIG. 4 is a functional block diagram illustrating an example of functions of a monitoring station according to one embodiment.

FIG. 5 illustrates an example of results obtained by a point calculation unit calculating a total point for each defect item.

FIG. 6 is a flowchart illustrating outline of an operation example of the monitoring station.

FIG. 7 illustrates a hardware configuration example of the monitoring station according to one embodiment.

### DESCRIPTION OF EMBODIMENTS

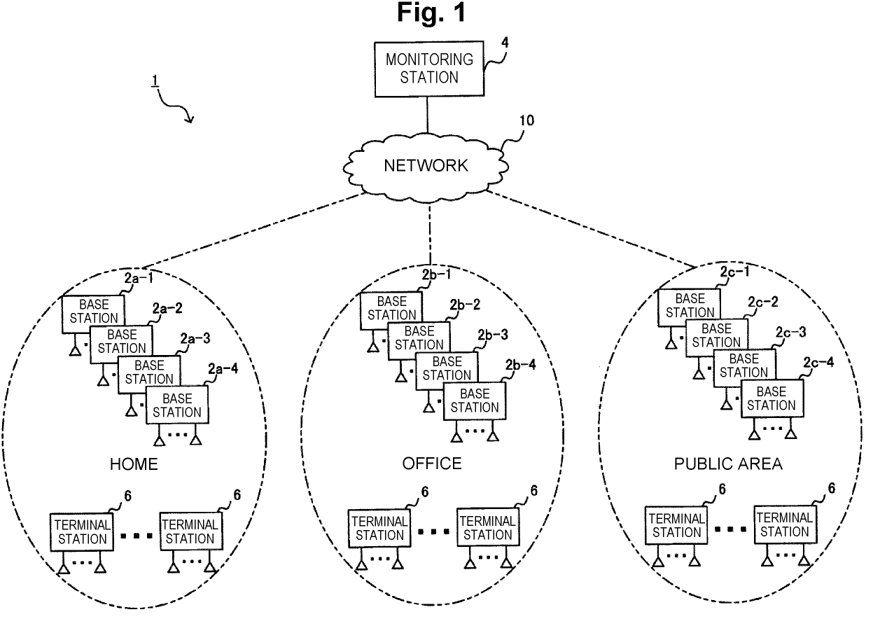

One embodiment of a wireless communication system will be described below using the drawings. FIG. 1 illustrates a configuration example of a wireless communication system 1 according to one embodiment. As illustrated in FIG. 1, the wireless communication system 1 is constituted by, for example, base stations 2a-1 to 2a-4, 2b-1 to 2b-4 and 2c-1 to 2c-4 being respectively connected to a monitoring station 4 via a network 10.

The base stations 2a-1 to 2a-4 are respectively provided indoors of, for example, home, and a plurality of terminal stations 6 located around the base stations 2a-1 to 2a-4 are connectable to the base stations 2a-1 to 2a-4.

The base stations 2b-1 to 2b-4 are respectively provided indoors of, for example, office which is larger than home, and a plurality of terminal stations 6 located around the base stations 2b-1 to 2b-4 are connectable to the base stations 2b-1 to 2b-4.

The base stations 2c-1 to 2c-4 are respectively provided outdoors of, for example, a public area which is larger than office, and a plurality of terminal stations 6 located around the base stations 2c-1 to 2c-4 are connectable to the base stations 2c-1 to 2c-4.

Note that while an example of a case will be described where the wireless communication system 1 operates in conformity with, for example, IEEE802.11ax standards, the wireless communication system 1 is not limited to this and may be a system which operates in conformity with other communication standards. Hereinafter, in a case where one of a plurality of components such as the base stations 2a-1 to 2a-4, 2b-1 to 2b-4 and 2c-1 to 2c-4 is not specified, the component will be simply abbreviated as the base station 2.

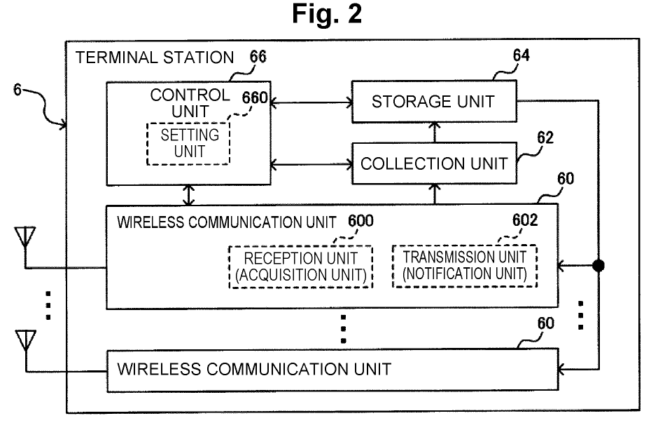

The terminal station 6 will be described first. FIG. 2 is a functional block diagram illustrating an example of functions of the terminal station 6. As illustrated in FIG. 2, the terminal station 6 includes, for example, a plurality of wireless communication units 60, a collection unit 62, a storage unit 64, and a control unit 66.

The wireless communication unit 60, which includes a reception unit (acquisition unit) 600 and a transmission unit (notification unit) 602, performs wireless communication with the base station 2 and other terminal stations 6.

The reception unit 600 acquires information by receiving signals transmitted by, for example, the base station 2 and other terminal stations 6 and outputs the information to the collection unit 62. The transmission unit 602 transmits (notifies), for example, a signal indicating information stored in the storage unit 64 to the base station 2 and other terminal stations 6. Note that the wireless communication units 60 may use different frequency bands or may employ different communication schemes or may perform communication using the same communication scheme.

The collection unit 62 collects wireless environment information, or the like, indicating wireless environments around, for example, the base station 2 and other terminal stations 6 via the wireless communication unit 60 and outputs the wireless environment information, or the like, to the storage unit 64. The storage unit 64 stores the wireless environment information, or the like, collected by the collection unit 62.

The control unit 66, which includes a setting unit 660, controls respective units which constitute the terminal station 6. For example, the setting unit 660 performs setting for operation of the terminal station 6 based on information acquired by the wireless communication unit 60 from the base station 2.

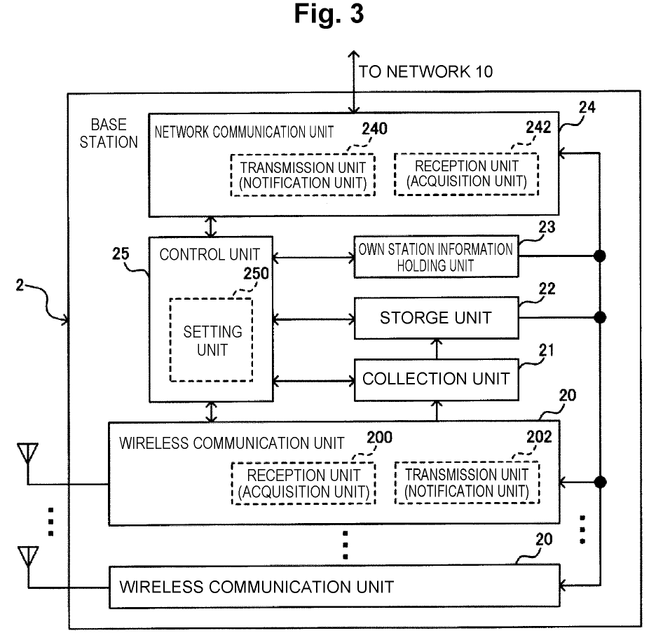

The base station 2 will be described next. FIG. 3 is a functional block diagram illustrating an example of functions of the base station 2. As illustrated in FIG. 3, the base station 2 includes, for example, a plurality of wireless communication units 20, a collection unit 21, a storage unit 22, an own station information holding unit 23, a network communication unit 24, and a control unit 25.

The wireless communication unit 20, which includes a reception unit (acquisition unit) 200 and a transmission unit (notification unit) 202, performs wireless communication with other base stations 2 and the terminal station 6.

The reception unit 200 acquires information by receiving signals transmitted by, for example, other base stations 2 and the terminal station 6 and outputs the information to the collection unit 21. The transmission unit 202 transmits (notifies), for example, information stored in the storage unit 64, own station information (which will be described later) held by the own station information holding unit 23, information acquired by the network communication unit 24 from the monitoring station 4, or the like, to other base stations 2 and the terminal station 6. Note that the wireless communication units 20 may use different frequency bands or may employ different communication schemes or may perform communication using the same communication scheme.

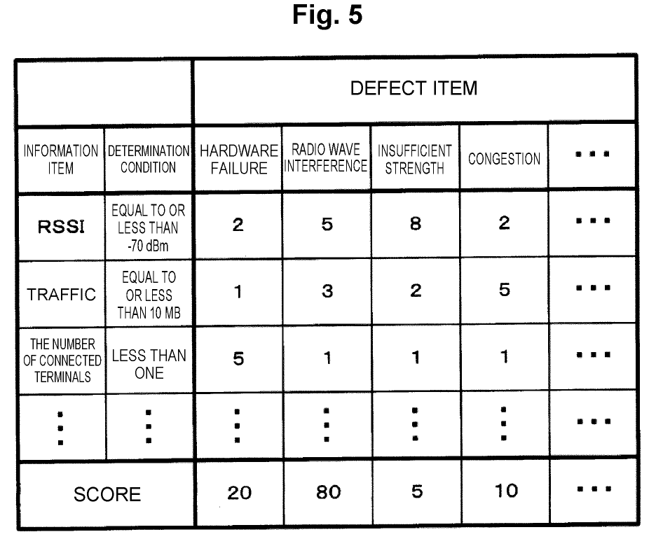

The collection unit 21 collects wireless environment information, or the like, including a plurality of information items (see FIG. 5) indicating wireless environments around, for example, other base stations 2 and the terminal station 6 from other base stations 2 and the terminal station 6 via the wireless communication unit 20 and outputs the wireless environment information, or the like, to the storage unit 22. Note that the wireless environment information may include information regarding communication between the base station 2 and the terminal station 6 and information regarding an operation state of the base station 2. The storage unit 22 stores the wireless environment information, or the like, collected by the collection unit 21.

The own station information holding unit 23 holds information regarding the base station 2. For example, the own station information holding unit 23 holds own station information including specifications, functions, or the like, of the own station, such as a frequency band and a communication scheme to be used by the base station 2, the number of connectable terminal stations and the number of wireless communication units 20.

The network communication unit 24, which includes a transmission unit (notification unit) 240 and a reception unit (acquisition unit) 242, performs wired communication or wireless communication with the monitoring station 4 via the network 10.

The transmission unit 240 transmits (notifies), for example, signals indicating the information stored in the storage unit 22 and the own station information held by the own station information holding unit 23 to the monitoring station 4. The reception unit 242 acquires information by receiving signals transmitted by the monitoring station 4. Further, the reception unit 242 outputs information which is received from the monitoring station 4 and which should be transmitted to the terminal station 6, to the wireless communication unit 20.

The control unit 25, which includes a setting unit 250, controls respective units which constitute the base station 2. For example, the setting unit 250 performs setting for operation of the base station 2 based on information acquired by the network communication unit 24 from the monitoring station 4, information acquired by the wireless communication unit 20 from the terminal station 6, or the like. Further, the setting unit 250 may perform setting for operation of the terminal station 6.

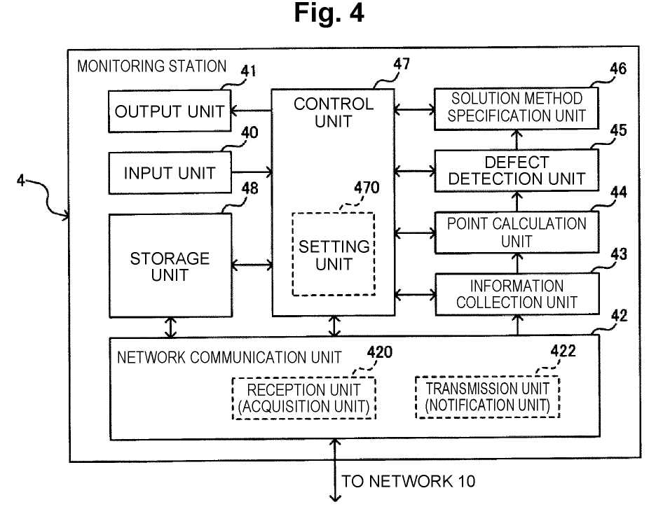

The monitoring station 4 will be described next. FIG. 4 is a functional block diagram illustrating an example of functions of the monitoring station 4 according to one embodiment. As illustrated in FIG. 4, the monitoring station 4 includes, for example, an input unit 40, an output unit 41, a network communication unit 42, an information collection unit 43, a point calculation unit 44, a defect detection unit 45, a solution method specification unit 46, a control unit 47, and a storage unit 48.

The input unit 40 accepts input (such as instructions and settings) by a worker with respect to the monitoring station 4. The output unit 41 outputs results, or the like, of processing by the monitoring station 4 so as to show the results, or the like, to the worker.

The network communication unit 42, which includes a reception unit (acquisition unit) 420 and a transmission unit (notification unit) 422, performs wired communication or wireless communication with the base stations 2a-1 to 2a-4, 2b-1 to 2b-4 and 2c-1 to 2c-4 via the network 10.

The reception unit 420 receives information respectively transmitted by the base stations 2a-1 to 2a-4, 2b-1 to 2b-4 and 2c-1 to 2c-4 and outputs the received information to the information collection unit 43. The transmission unit 422 transmits information, or the like, processed by the monitoring station 4 to the base stations 2a-1 to 2a-4, 2b-1 to 2b-4 and 2c-1 to 2c-4.

The information collection unit 43 collects information received by the reception unit 420 and outputs the information to the point calculation unit 44. For example, the information collection unit 43 collects wireless environment information such as an operation log including a plurality of information items indicating wireless environments around each base station 2 and each terminal station 6 from each of the base stations 2a-1 to 2a-4, 2b-1 to 2b-4 and 2c-1 to 2c-4 and outputs the collected results to the point calculation unit 44. The information items included in the wireless environment information include, for example, strength of a received signal strength indicator (RSSI), traffic, the number of terminal stations 6 connected to the base station 2 (the number of connected terminals), channel utilization, a data rate, a channel transition log, or the like.

The point calculation unit 44 calculates a total point (score) of points to be provided to each of a plurality of defect items determined in advance in a case where a determination condition determined in advance for each information item is satisfied and outputs a calculation result to the defect detection unit 45. The defect items include, for example, a hardware failure, radio wave interference, insufficient strength, congestion, or the like.

FIG. 5 illustrates results obtained by the point calculation unit 44 calculating a total point for each defect item. For example, the point calculation unit 44 determines whether or not a determination condition is satisfied for each information item, and in a case where the determination condition is satisfied, provides a point weighted for each defect item to each information item. The point calculation unit 44 then performs calculation of adding up the points respectively provided to the information items, for each defect item.

Specifically, in a case where radio wave interference is set as the defect item, the point calculation unit 44 adds five points in a case where the RSSI is equal to or less than -70 dBm, does not add three points in a case where traffic is greater than 10 MB, adds one point in a case where the number of connected terminals is smaller than one, and sets a total point as 80 by also adding points of other information items.

Further, in a case where at least one of an environment where the base station 2 is provided and a defect item is different, the point calculation unit 44 may determine whether or not a determination condition is satisfied using different thresholds (determination thresholds) and may calculate a total point of points respectively provided to the information items.

The defect detection unit 45 (FIG. 4) detects whether or not a defect listed as one or more of the defect items occurs based on the total point calculated by the point calculation unit 44 and outputs a detection result to the solution method specification unit 46. For example, the defect detection unit 45 compares the score with a threshold set in advance and detects whether or not a defect listed as the defect items occurs.

As a specific example, in a case where a threshold for determining whether or not a defect regarding radio wave interference occurs is 70, the defect detection unit 45 detects that a defect regarding radio wave interference occurs if the score is 80 as in the result illustrated in FIG. 5.

Further, in a case where a threshold (detection threshold) for determining whether or not a defect regarding a hardware failure occurs is 80, the defect detection unit 45 detects that a defect regarding a hardware failure does not occur if the score is 20 as in the result illustrated in FIG. 5.

Further, the defect detection unit 45 may apply different weights to points or may set different thresholds, or the like, for determining whether or not a defect occurs in accordance with a difference in environments where the base stations 2a-1 to 2a-4, 2b-1 to 2b-4 and 2c-1 to 2c-4 are provided.

In other words, in a case where there is a difference in at least one of environments where the base stations 2 are provided and the defect items, the defect detection unit 45 may detect whether or not a defect listed as the defect items occurs using different detection thresholds.

For example, a threshold for determining whether or not a defect regarding a hardware failure of the base stations 2c-1 to 2c-4 provided outdoors occurs may be set lower than a threshold for determining whether or not a defect regarding a hardware failure of the base stations 2a-1 to 2a-4 and 2b-1 to 2b-4 provided indoors occurs.

Further, the defect detection unit 45 may detect a probability indicating a likelihood of occurrence of a defect based on a ratio of a score with respect to a threshold for determining whether or not a defect occurs.

In other words, the monitoring station 4 can detect whether or not a plurality of defects listed as a plurality of defect items occur through parallel processing based on a plurality of information items.

The solution method specification unit 46 specifies a solution method for each of the defect items detected by the defect detection unit 45. For example, in a case where the defect detection unit 45 detects that a defect regarding radio wave interference occurs in the wireless communication system 1, the solution method specification unit 46 specifies a solution method for avoiding radio wave interference. For example, the solution method specification unit 46 may hold a look-up table, or the like, in which defect items (defects) are associated with solution methods and may specify a solution method for the defect based on the look-up table, or the like.

The control unit 47, which includes a setting unit 470, controls respective units which constitute the monitoring station 4. Further, the control unit 47 causes results obtained by respective units which constitute the monitoring station 4 processing information, to be stored in the storage unit 48. For example, the control unit 47 outputs the information collected by the information collection unit 43, the points and the total point calculated by the point calculation unit 44, whether or not a defect occurs detected by the defect detection unit 45, the solution method specified by the solution method specification unit 46, or the like, to the output unit 41 and the storage unit 48.

The setting unit 470 performs setting for the respective units which constitute the monitoring station 4. For example, the setting unit 470 performs setting for the information collection unit 43, the point calculation unit 44, the defect detection unit 45 and the solution method specification unit 46 based on settings input by the worker via the input unit 40.

The storage unit 48 outputs the stored information to the output unit 41 and the network communication unit 42 in accordance with control by the control unit 47. In other words, the output unit 41 can output the defect items detected by the defect detection unit 45 and the solution method specified by the solution method specification unit 46. Further, the network communication unit 42 can transmit the information stored in the storage unit 48 to the base stations 2a-1 to 2a-4, 2b-1 to 2b-4 and 2c-1 to 2c-4.

Note that the monitoring station 4 may be able to set a combination, addition and deletion of information items to be used by the point calculation unit 44 to calculate a score, change of the determination condition, or the like, based on settings input via the input unit 40. Further, the monitoring station 4 may be able to set addition and deletion of defect items (defects) to be detected by the defect detection unit 45, weights of points, or the like, based on settings input via the input unit 40. Further, the monitoring station 4 may learn detection of a defect, and the control unit 47 may change the settings described above.

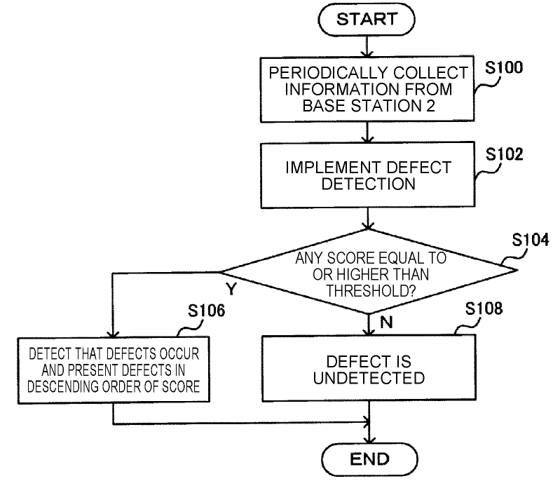

FIG. 6 is a flowchart illustrating outline of an operation example of the monitoring station 4. As illustrated in FIG. 6, the monitoring station 4 periodically collects information from each base station 2 (S100). The monitoring station 4 then detects a defect for each defect item (S102).

The monitoring station 4 determines whether or not there is a score equal to or greater than a threshold for determining whether or not a defect occurs at the defect detection unit 45 (S104), and in a case where there is a score equal to or greater than the threshold (S104: Yes), the processing proceeds to processing in S106, and in a case where there is no score equal to or greater than the threshold (S104: No), the processing proceeds to processing in S108.

In the processing in S106, at the monitoring station 4, the defect detection unit 45 detects that a defect occurs, and the output unit 41 presents the detected defect to the worker in descending order of the scores.

In the processing in S108, the monitoring station 4 determines that a defect is undetected.

In this manner, in the wireless communication system 1, the monitoring station 4 collects wireless environment information including a plurality of information items indicating wireless environments and detects whether or not one or more defects occur based on scores respectively calculated for a plurality of defect items, so that it is possible to efficiently detect whether or not a defect occurs.

Note that part or all of respective functions of the base station 2, the monitoring station 4 and the terminal station 6 may be constituted with hardware such as a programmable logic device (PLD) and a field programmable gate array (FPGA) or may be constituted as a program to be executed by a processor such as a CPU.

For example, the monitoring station 4 according to the present invention can be implemented using a computer and a program, and the program can be recorded in a storage medium or can be provided through a network.

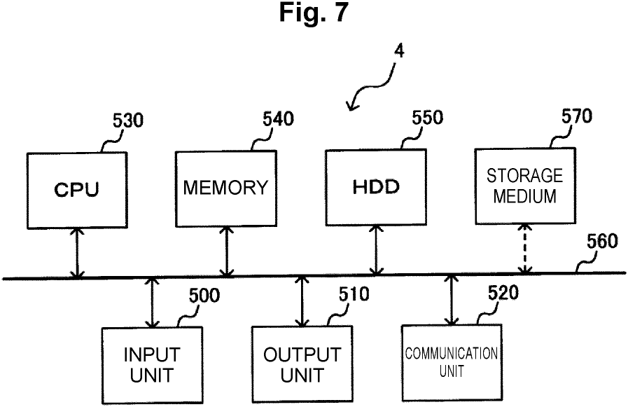

FIG. 7 illustrates a hardware configuration example of the monitoring station 4 (the base station 2, the terminal station 6) according to one embodiment. As illustrated in FIG. 7, for example, the monitoring station 4 includes an input unit 500, an output unit 510, a communication unit 520, a CPU 530, a memory 540 and an HDD 550 which are connected via a bus 560 and has functions as a computer. Further, the monitoring station 4 is constituted so as to be able to input/output data to/from a computer-readable storage medium 570.

The input unit 500 is, for example, a keyboard, a mouse, or the like. The output unit 510 is, for example, a display device such as a display. The communication unit 520, which is, for example, a wired or wireless network interface, can perform a plurality of wireless communications.

The CPU 530 controls respective units which constitute the monitoring station 4 and performs the above-described calculation, or the like. The memory 540 and the HDD 550 constitute the above-described storage unit 48 which stores data. Particularly, the memory 540 stores respective pieces of data to be used in the above-described calculation. The storage medium 570 can store a wireless communication program, or the like, which causes functions of the monitoring station 4 to be executed. Note that an architecture which constitutes the monitoring station 4 (the base station 2, the terminal station 6) is not limited to the example illustrated in FIG. 7.

In other words, it is assumed here that the “computer” described here includes hardware such as an OS and peripheral equipment. Further, the “computer-readable storage medium” refers to a storage device such as a portable medium including a flexible disk, an magnetooptical disk, a ROM, a CD-ROM, or the like.

Further, the “computer-readable storage medium” may include a medium which dynamically holds a program in a short period of time such as a communication line in a case where a program is transmitted via a network such as the Internet or a communication line such as a phone line, and a medium which holds a program in a fixed period such as a volatile memory inside a computer which becomes a server or a client in that case.

While the embodiment of the present invention has been described above with reference to the drawings, the above-described embodiment is merely an example of the present invention, and it is obvious that the present invention is not limited to the above-described embodiment. Thus, components may be added, omitted, replaced or changed within a range not deviating from the technical idea and the scope of the present invention.

### REFERENCE SIGNS LIST

1 Wireless communication system
2a-1 to 2a-4, 2b-1 to 2b-4, 2c-1 to 2c-4 Base station
4 Monitoring station
6 Terminal station
20 Wireless communication unit
21 Collection unit
22 Storage unit
23 Own station information holding unit
24 Network communication unit
25 Control unit
40 Input unit
41 Output unit
42 Network communication unit
43 Information collection unit
44 Point calculation unit
45 Defect detection unit
46 Solution method specification unit
47 Control unit
48 Storage unit
60 Wireless communication unit
62 Collection unit
64 Storage unit
66 Control unit
200, 242, 420, 600 Reception unit (acquisition unit)
202, 240, 422, 602 Transmission unit (notification unit)
250, 470, 660 Setting unit
500 Input unit
510 Output unit
520 Communication unit
530 CPU
540 Memory
550 HDD
560 Bus
570 Storage medium

1. A wireless communication system comprising:
a plurality of base stations to which terminal stations are connectable; and
a monitoring station which monitors each of the base stations,
the monitoring station comprising:
an information collection unit configured to collect wireless environment information including a plurality of information items indicating wireless environments around the base stations and the terminal stations, from each of the base stations;
a point calculation unit configured to calculate a total point of points to be respectively provided to a plurality of defect items determined in advance in a case where a determination condition determined in advance for each of the information items is satisfied; and a defect detection unit configured to detect whether or not a defect listed as one or more of the defect items occurs based on the total point calculated by the point calculation unit.

2. The wireless communication system according to claim 1, wherein in a case where there is a difference in at least one of environments where the base stations are provided and the defect items, the point calculation unit determines whether or not the determination condition is satisfied using different determination thresholds and calculates a total point of points to be provided for each of the information items.

3. The wireless communication system according to claim 1,
wherein in a case where there is a difference in at least one of environments where the base stations are provided and the defect items, the defect detection unit detects whether or not a defect listed as the defect items occurs using different detection thresholds.

4. The wireless communication system according to claim 1, further comprising:
a solution method specification unit configured to specify a solution method for each of the defect items; and
an output unit configured to output the defect items detected by the defect detection unit and the solution method specified by the solution method specification unit.

5. A monitoring station which monitors each of a plurality of base stations to which terminal stations are connectable, the monitoring station comprising:
a processor; and
a storage medium having computer program instructions stored thereon, when executed by the processor, perform to:
collect wireless environment information including a plurality of information items indicating wireless environments around the base stations and the terminal stations, from each of the base stations;
calculate a total point of points to be respectively provided to a plurality of defect items determined in advance in a case where a determination condition determined in advance for each of the information items is satisfied; and detect whether or not a defect listed as one or more of the defect items occurs based on the total point
.

6. A defect detection method for detecting whether or not a defect listed as defect items occurs for a wireless communication system comprising a plurality of base stations to which terminal stations are connectable, the defect detection method comprising:
an information collection step of collecting wireless environment information including a plurality of information items indicating wireless environments around the base stations and the terminal stations, from each of the base stations;
a point calculation step of calculating a total point of points to be respectively provided to a plurality of defect items determined in advance in a case where a determination condition determined in advance for each of the information items is satisfied; and a defect detection step of detecting whether or not a defect listed as one or more of the defect items occurs on a basis of the calculated total point.

7. A non-transitory computer-readable medium having computer-executable instructions that, upon execution of the instructions by a processor of a computer, cause the computer to function as the wireless communication system according to claim 1.
